(19) United States
(12) Patent Application Publication
(10) Pub. No.: US 2024/0407280 A1
(43) Pub. Date: Dec. 12, 2024

(54) MOBILE SEED TREATMENT APPLICATION DEVICE

(71) Applicants: Mark Ralph Haley, Parys (ZA); Douglas W. Pool, Silver Spring, MD (US)

(72) Inventors: Mark Ralph Haley, Parys (ZA); Douglas W. Pool, Silver Spring, MD (US)

(21) Appl. No.: 18/737,523

(22) Filed: Jun. 7, 2024

Related U.S. Application Data
(60) Provisional application No. 63/471,627, filed on Jun. 7, 2023.

(51) Int. Cl. A01C 1/06

(52) U.S. Cl. CPC A01C 1/06

(57) ABSTRACT

An automated seed treatment device is disclosed, generally comprising a hopper for loading seeds and feeding them down into the lower end of an upwardly inclined auger assembly. Seeds loaded into the hopper travel up the auger assembly beneath a dosing drum comprising partitioned chambers mounted piggyback on the auger. The dosing drum comprises agitators dispensing a calibrated amount of seed coating into the auger assembly for coating seeds therein. Coated seeds travel up the inclined auger assembly to a double-chute dispenser head for bagging. The device comprises a wheel assembly and a stand for transport. The auger is driven at a fixed speed by a motorized pulley mechanism, which also drives the agitators. Seed treatments may be calibrated and sprayed onto the seeds as they travel up the auger assembly in a steady and accurate dosage.

### CROSS-REFERENCE TO RELATED APPLICATIONS

This application claims the benefit of priority of U.S. Provisional Pat. App. Ser. No. 63/471,627, the contents of which are incorporated by reference herein in their entirety.

### STATEMENT REGARDING FEDERALLY SPONSORED RESEARCH OR DEVELOPMENT

The invention described herein was developed without federal funding.

### BACKGROUND OF THE INVENTION

### 1. Field of the Invention

The present invention relates generally to seed treaters and, in particular, a mobile seed treater that is transportable, reliable, accurate and inexpensive to maintain.

### 2. Description of the Background

Seed treatment devices or “seed treaters” are used to apply additives such as biocides, fertilizers, hormones, pesticides, fungicides and the like to seeds before planting them.

Some of the most common types of seed treatment machines include drum seed treaters that tumble the seeds in a drum with a liquid or powder treatment. This type of machine is relatively inexpensive and easy to use, but it can be difficult to get an even coating of the treatment on the seeds. Moreover, volumes are very low, and the usage is labor intensive. Air-blast seed treaters blow the seeds through a stream of air that is mixed with a liquid or powder treatment. This type of machine is much more expensive than drum seed treaters, but it provides a more even coating of the treatment on the seeds. Vacuum seed treaters work by sucking the seeds into a chamber where they are coated with a liquid or powder treatment. This is generally the most expensive type of seed treatment machine, but it provides the most even coating of the treatment on the seeds. Given the variety of existing seed treatment machines it is important to consider the size of one's operation, the type of seeds to be planted, and the budget. The capacity of a seed treatment machine is measured by the number of seeds it can treat per hour, and high value crops demand precision coatings. However, seed treatment machines can range in price from a few hundred dollars to many thousands. For small-scale farmers a drum seed treater may be a good option. Indeed, farmers often improvise, using a cement mixer or the like which is extremely time consuming. Alternatively, smaller farmers may outsource to a company that specializes in seed treatment, but this too is costly and adds wait time. On the other hand, large-scale farmers or high-value crop farmers prefer air-blast or vacuum seed treaters as a better option.

What is needed is a small portable compact and inexpensive solution that provides higher capacity and precision at a value price. U.S. Pat. No. 11,968,919 discloses a seed treater sized to fit within a pickup truck bed so that it can be more easily transported. However, this device is still large, complicated, and expensive. What is needed is a mobile seed treater that can be easily transported, and is reliable, accurate and inexpensive to maintain.

### BRIEF SUMMARY OF THE INVENTION

According to an embodiment of the invention, an automated seed treatment device is disclosed, generally comprising a hopper for loading seeds and feeding them down into the lower end of an upwardly inclined auger assembly. Seeds loaded into the hopper travel up the auger assembly beneath a dosing drum mounted piggyback on the auger. The dosing drum contains a plurality of internally partitioned chambers each with an agitator, and the agitators dispense a calibrated amount of liquid seed coating back into the auger assembly for coating the seeds therein. The coated seeds travel up the inclined auger assembly past the dosing drum to a double-chute dispenser head for bagging. The auger assembly is supported at an incline by a wheel assembly at the lower rear end and a stand at the upper front end for transport. The auger assembly includes a two-stage internal auger driven at a fixed speed by a motorized pulley mechanism, that same mechanism also driving the agitators of the dosing drum at a different fixed speed. The seed treating device ensures that a calibrated volume of additive from each partitioned chamber is sprayed onto the seeds as they travel up the auger assembly. The entire turning/mixing/flowing process ensures that liquid seed treatments (coatings) are added automatically in a steady and accurate dosage and that all seeds are coated evenly with just the right amount of coating, all without damaging the seeds.

The present invention is described in greater detail in the detailed description of the invention, and the appended drawings. Additional features and advantages of the invention will be set forth in the description that follows, will be apparent from the description, or may be learned by using the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which.

FIG. 1 is a front view of a seed treatment device according to an embodiment of the invention.

FIG. 2 is a right-side perspective view of the seed treatment device of FIG. 1.

FIG. 3 is a left side perspective view of the seed treatment device of FIGS. 1-3.

FIG. 4 is a rear view of the seed treatment device of FIGS. 1-2.

FIG. 5 shows a top view of the of the seed treatment device of FIGS. 1-4 with the cover of dosing drum open.

FIG. 6 shows a perspective view of the auger.

FIG. 7 illustrates the motorized pulley mechanism.

FIG. 8 is a side view of the seed treatment device with enlarged inset of the fluid connections to dosing drum.

### DETAILED DESCRIPTION OF THE INVENTION

Reference will now be made in detail to preferred embodiments of the present invention, examples of which are illustrated in the accompanying drawings. Wherever possible, the same reference numbers will be used throughout the drawings to refer to the same or like parts.

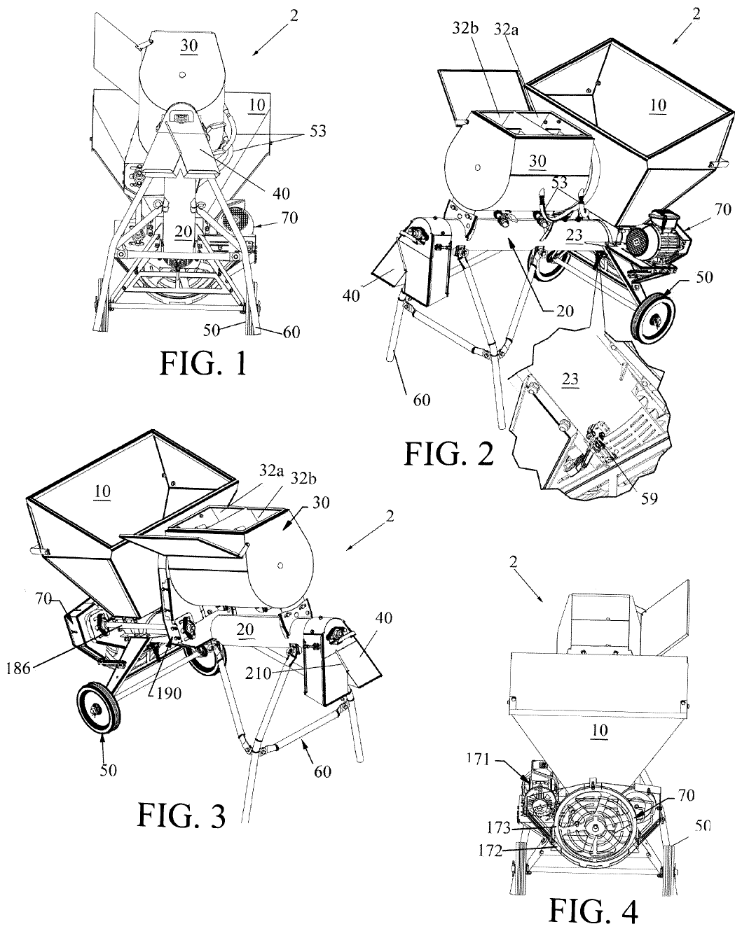

As seen collectively in FIGS. 1-4, the present invention is a seed treatment device 2 generally comprising a hopper 10 for loading seeds and feeding them down through a port into the lower end of an upwardly inclined auger assembly 20. Seeds loaded into hopper 10 travel up the auger assembly 20 beneath a dosing drum 30 carried piggyback on the auger assembly 20. Opening the hinged cover 31 of the dosing drum 30 reveals internally partitioned chambers 32a, 32b . . . 32n, each chamber serving as a reservoir of liquid seed coating such as, for example, biocides, fertilizers, hormones, pesticides, fungicides and the like. Each chamber of the dosing drum 20 contains a rotary agitator mounted on a drive shaft that is driven at a fixed speed by a motorized pulley mechanism 70. The rotary agitators mix the liquid seed coatings and deposit a measured amount into internal collection troughs, where they drain downward through discharge tubes 53 into the auger assembly 20 for coating the seeds. The discharge tubes 53 are connected to spray jets located downstream along the top of the auger assembly 20.

The auger assembly 20 inducts seeds from hopper 10, conveys them upstream beneath the spray jets where they are coated, and further up beneath the dosing drum 30 to a double-chute dispenser head 40 where the coated seeds are ejected.

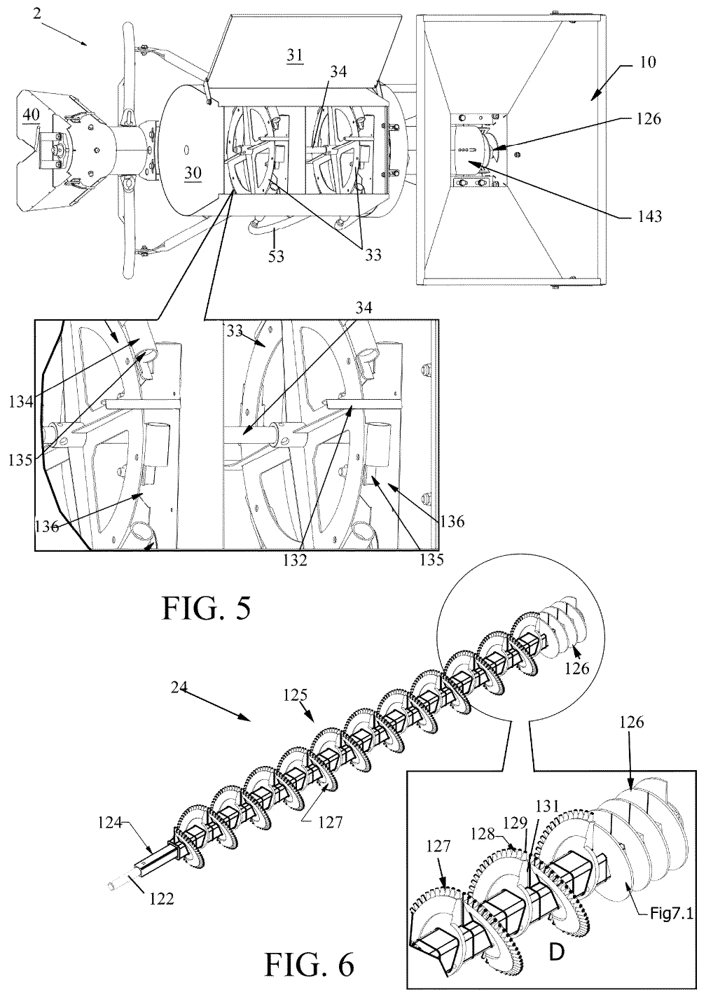

The auger assembly 20 is supported at an incline by a wheel assembly 50 extended downward at the lower rear end and a bipedal stand 60 at the upper front end. The auger assembly 20 includes an internal auger (to be described) that is driven by an external pulley mechanism 70. One skilled in the art will understand that alternative support assemblies may be used to suit a user's needs, such as making the bipedal stand 60 foldable or eliminating it in favor of a tow hitch connector to connect to a vehicle's tow ball. FIG. 5 shows a top view of the of the seed treatment device 2 of FIGS. 1-4 with the hinged cover 31 of dosing drum 30 open to reveal two internally partitioned chambers 32a, 32b, each chamber containing an agitator wheel 33. Both agitator wheels 33 are mounted on a common drive shaft 34 that traverses all chambers. An enlarged inset of the agitator wheels 33 is also shown. Each agitator wheel 33 comprises a rotating disk that rotates at a fixed speed of approximately 14 rpm. The agitator wheels 33 each contain orbital features 132, 134 both for mixing the liquid seed coatings and for transferring a calibrated supply to the discharge tubes 53. In the illustrated embodiment the mixing features include scrapers 132 formed as distal cross-pieces joined to medial spokes in a T-configuration as shown which keeps the additive mixed and ensures that thick sediment does not settle on the bottom of the drum 30.

Each partitioned chamber 32a, 32b also has an internal collection trough 136 that feeds the respective discharge conduits 53. Rotating measuring cups 134 on each agitator wheel 33 dip into the liquid additive, pick up a calibrated amount, and deposit it into the collection trough 136 where it drains down through discharge tubes 53 and is sprayed into the auger assembly 20. Measuring cups 134 are closed-bottom open-mouth cups preferably each provided with a removable and resizable plastic insert 135 that establishes the size of the mouth, thereby calibrating the volume of additive that is picked up by each measuring cup 134 as they rotate as a function of time. As the measuring cups 134 continue to rotate toward the top of their rotation they begin to empty their calibrated amount of additive into a collection trough 136, and the plastic inserts 135 set into the mouth of each measuring cup 134 extend a forward lip to guide the additive into the trough 136. The trough 136 directs the additive down and out of the dosing drum 30 through discharge tubes 53, each discharge tube 53 being connected downstream to spray jets spaced along the top of the auger assembly 20. This configuration ensures that a timed supply of liquid additive from each partitioned chamber 32a, 32b is sprayed onto the seeds early during their travel up the auger assembly 20, such that the seeds are thoroughly mixed and uniformly coated during the remainder of their travel to dispensing head 40. After the seeds are fully coated, they are ejected from the double-chute dispenser head 40 into bags or containers and ready for planting. The entire turning/mixing/flowing process ensures that multiple liquid seed coatings are added automatically in a steady and accurate dosage, and that all seeds are mixed and coated evenly with just the right amount of coating, all without damaging the seeds.

Referring back to FIG. 2 the auger assembly 20 is contained inside a steel auger tube 23 having an inside diameter of 146.4 millimeters (mm) and a length within a range of between 1500 mm and 1800 mm. The auger tube 23 is held at approximately a 26-degree angle to achieve the correct back flow, which works with the internal auger 24 to produce an even flow and coating on the seeds. The auger tube 23 has a topside inlet port in communication with hopper 10, and a trapdoor drain port 59 bottom-side for emptying and cleaning.

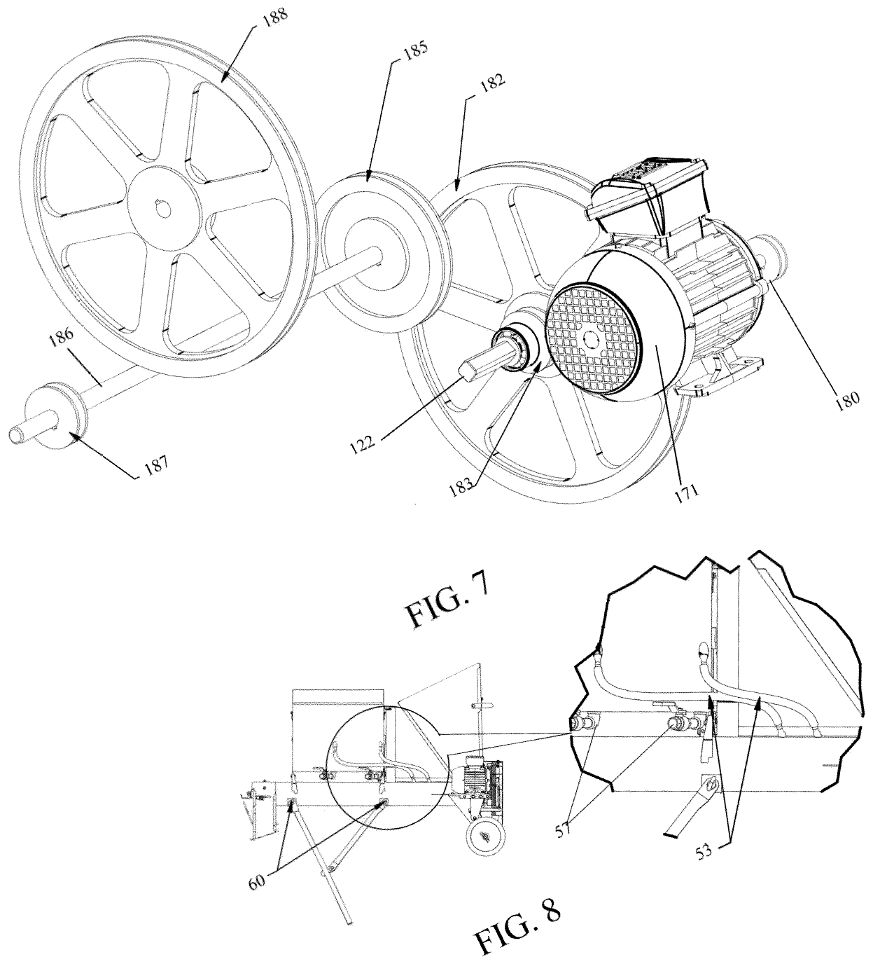

FIG. 6 is an isolated view of the internal auger 24 with enlarged inset illustrating its distinct stages. Generally, the auger 24 includes an elongate axle 122 that extends the length of the auger tube 23 and is rotatably seated therein. A continuous helical blade set 125 is carried on and extends the length of the axle 122. As seen in the inset the helical blade set 125 comprises a short section of lead-screw auger blade 126 configured to receive seeds from hopper 10 and transfer them up into the auger tube 23, and a longer section of mixing auger blade 127 configured for mixing the seeds and additive. The lead-screw auger blade 126 is approximately 220 mm long with a diameter of between 110-120 mm and is configured with a smaller helical pitch of approximately 60 mm, and smooth edges. In contrast, the mixing auger blade 127 is configured with a larger helical pitch and mixing features to mix the seeds and additive well.

The mixing features of the mixing auger blade 127 include edgewise fingers 129 that protrude radially plus flattened surfaces 131 that extend axially. The flattened surfaces 131 cause both a mixing and upward feeding action. In two-stage operation the lead screw auger section 126 establishes the upward flowrate of seeds in auger tube 23. The mixing auger blade 127 holds a lesser volume of seeds per revolution then the lead-screw auger section 126, such that seeds are not compacted together during the mixing process. This ensures uniform coating and avoids seed damage while moving up the tube 23.

The different stages of the helical blade set 125 and mixing features are economically implemented as plastic-molded segments that are inserted end-to-end onto a keyed tube 124 of square cross-section that rides on axle 122. The plastic-molded segments may generally be polyurethane casted segments that slip over a 25.4×25.4×2 mm tube 124. However, the edgewise fingers 129 that protrude radially may be separately formed softer protruding bristles which help to prevent the seeds from getting damaged.

Referring back to FIG. 5, the hopper 10 comprises a trapezoidal open-topped bin that tapers downward and is configured to funnel seed content out of the port at the bottom into the auger tube 23 and into the lead-screw auger blade 126. There is a sliding damper plate 143 between the hopper 10 port and the auger tube 23 to meter the influx of seeds, and to ensure a gradual feed even when seeds are dumped therein. This avoids compressing and jamming the lead-screw auger blade 126.

FIG. 7 illustrates the motorized pulley mechanism 70, all driven by an electric motor 171 such as, for example, a 1.1 kW (1.5HP) Single Phase Capacitor Run 4 Pole AC Motor for use at fixed speed. A first pulley 180 is mounted on the motor 171 shaft, and the first pulley 180 is connected by a first pulley belt to a large-diameter second pulley 182. The second pulley 182 rides upon the distal end of the auger axle 122 and effectively drives rotation of the auger 24.

A third pulley 183 is mounted on the auger axle 122 inwardly of the second pulley 182, and the third pulley 183 is connected by a second pulley belt to a fourth pulley 185. The fourth pulley 185 rides upon the distal end of a dosing axle 186 that indirectly drives rotation of the agitator wheels 33 on drive shaft 34. To do this, the dosing axle 186 is rotatably joined into a safety bracket 190 (see FIG. 3) that attaches the auger tube 23 to the dosing bin 30. The safety bracket 190 also provides an enclosure, and a fifth pulley 187 is mounted on the end of dosing axle 186 inside the enclosed safety bracket 190. The fifth pulley 187 is connected by a third pulley belt to a sixth pulley 188 mounted on drive shaft 34 and that directly drives rotation of the agitator wheels 33 also on drive shaft 34.

An exemplary set of dimensions is as follows:
First Pulley 180=56 mm diameter
Second Pulley 182=400 mm diameter
Third Pulley 183=65 mm diameter
Fourth Pulley 185=170 mm diameter
Fifth Pulley 187=65 mm diameter
Sixth Pulley 188=400 mm diameter

Given the foregoing dimensions, first pulley 180 rotates at 1400 rpm and drives second pulley 182 via belt at 228 rpm. Third pulley 183 rotates at 228 rpm and drives fourth pulley 185 via belt rotating at 87 rpm. Fourth pulley 185 rotates at 87 rpm and is connected to fifth pulley 187 via shaft 186 rotating at 87 rpm, which likewise establishes the speed of the auger 24. Fifth pulley 187 rotates at 87 rpm and is connected to sixth pulley 188 via a belt rotating at 14 rpm, which establishes the speed of the agitators. Thus, a motor 171 operating at 1400 rpm is reduced to a final agitator drive of 14 rpm, while the auger 24 turns at 227.5 revolutions per minute. This ratio allows for a seed flow of three metric tons per hour depending on the seeds and the size of the seeds. The foregoing ratios can be changed, but thru extensive testing it has been found that this is an optimum ratio for maximum flow without damaging the seeds.

Referring back to FIG. 1, the double-discharge chute 40 is removably affixed by toggle clamps on either side and has an internal directional plate with throw-over lever 210 that guides the seeds through either left or right chute as required. This dual-chute option expedites filling bags: when one bag is full, the user simply connects another to the other chute and flips the throw-over lever 210. This way the device can be run continuously.

FIG. 8 is a side view of the seed treatment device 2 with enlarged inset of the fluid connections to dosing drum 30. The dosing drum 30 rides piggyback atop the auger tube 23 at the same slight angle. A discharge conduit 53 exits each internally partitioned chamber 32a, 32b and connects along the top of the auger assembly 20 further downstream toward the lower end. The calibrated amount of additive liquid flows through the discharge tubes 53 into the auger 23 and onto the seeds being treated.

To clean the device, the dosing drum 30 is drained by lever-operated spigots 57 underneath. The auger 24 is then removed forwardly by releasing both toggle clamps on either side of the dispensing chute 40, removing, and then removing the auger 24 by the handle on the front. Excess seeds are then drained out of trap door 59 at the lower end of the auger tube 23 by releasing the toggle clamp (FIG. 2 inset). A plastic bag can be placed over the motor and the device can be hosed down or pressure washed as all the other parts are mechanical.

The device 2 described above is well-suited for both small and large farms and can maintain a capacity of about three tons of seed per hour depending on seed size and type of seeds. Moreover, the device 2 is portable, compact, reliable, accurate and inexpensive to maintain.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. An automated seed treatment device, comprising:
an auger assembly comprising an elongate auger tube with a topside inlet at a first end and a distal outlet at a second end, and an auger mounted on an auger axle and rotatably seated in said auger tube, said auger bearing helical splines;
a hopper affixed above the auger assembly proximate the first end and in communication with the topside inlet;
a dosing drum carried piggyback atop the auger tube, the dosing drum comprising at least one reservoir, a collection trough, and an agitator mounted on an agitator axle and rotatably seated in said dosing drum within said reservoir and proximate said collection trough, the rotary agitator having a collection cup for transferring contents of said reservoir into said collection trough at a calibrated rate;
at least one discharge tube in fluid connection between said collection trough and said auger tube;
a pulley mechanism comprising a motor and a plurality of pulleys and corresponding number of belts connecting said motor to both said dosing axle and said auger axle; and
a wheeled stand assembly for maintaining said auger tube at an incline.

2. The automated seed treatment device of claim 1, wherein the distal outlet is connected to a double-chute dispenser head.

3. The automated seed treatment device of claim 1, wherein the auger assembly is supported at an incline by a wheel assembly proximate the first end and a stand proximate the second end.

4. The automated seed treatment device of claim 1, wherein the dosing drum comprises a plurality of internally partitioned chambers, each chamber comprising a rotary agitator mounted on mounted on an agitator axle traversing all chambers that is driven at a fixed speed by the pulley mechanism.

5. The automated seed treatment device of claim 1, wherein the at least one discharge tube is connected to a corresponding spray jet proximate the second end of the auger tube.

6. The automated seed treatment device of claim 4, wherein the fixed speed is approximately fourteen revolutions per minute.

7. The automated seed treatment device of claim 1, wherein the agitator comprises a scraper, a measuring cup, or both.

8. The automated seed treatment device of claim 1, wherein the auger assembly is held at an approximately 26-degree angle.

9. The automated seed treatment device of claim 1, wherein the auger comprises a short lead-screw section of helical splines to receive seeds from the hopper and transfer them up into the auger tube, and a longer mixing section of helical splines configured for mixing seeds with additives.

10. The automated seed treatment device of claim 9, wherein the additives are selected from the group consisting of biocides, fertilizers, hormones, pesticides, fungicides, and combinations thereof.

11. The automated seed treatment device of claim 1, wherein the auger comprises mixing features selected from the group consisting of edgewise fingers that protrude radially, flattened surfaces that extend axially, or combinations thereof.

12. The automated seed treatment device of claim 11, wherein the mixing features are implemented as plastic-molded segments that are inserted end-to-end onto a keyed tube surrounding the auger axle.

13. The automated seed treatment device of claim 1, further comprising a sliding damper plate between a port of the hopper and the auger tube to meter the influx of seeds into the auger tube.

14. The automated seed treatment device of claim 1, wherein the pulley mechanism comprises an electric motor.

15. The automated seed treatment device of claim 14, wherein the electric motor is a 1.1-kilowatt, 1.5 horsepower single phase capacitor run 4-pole alternating current motor for use at fixed speed.

16. The automated seed treatment device of claim 1, wherein the dimensions of the plurality of pulleys is six pulleys, wherein the diameter of a first pulley is 56 mm, the diameter of a second pulley is 400 mm, the diameter of a third pulley is 65 mm, the diameter of a fourth pulley is 170 mm, the diameter of a fifth pulley is 65 mm diameter, and the diameter of a sixth pulley is 400 mm diameter.

17. The automated seed treatment device of claim 16, wherein the first pulley rotates at 1400 rpm and drives second pulley via belt at 228 rpm, the third pulley rotates at 228 rpm and drives the fourth pulley via belt at 87 rpm, the fourth pulley rotates at 87 rpm and is connected to the fifth pulley via shaft rotating at 87 rpm, which likewise establishes the speed of the auger 24.

18. The automated seed treatment device of claim 16, wherein the fifth pulley rotates at 87 rpm and is connected to the sixth pulley via a belt rotating at 14 rpm, which establishes the speed of the agitator.

19. The automated seed treatment device of claim 2, wherein the double-discharge chute is removably affixed by toggle clamps on either side and comprises an internal directional plate with throw-over lever that guides the seeds through either a left or right chute.

20. The automated seed treatment device of claim 1, wherein the dosing drum comprises a trap door proximate the first end of the auger tube for draining excess seeds.
